(19) United States
(12) Patent Application Publication
(10) Pub. No.: US 2025/0276263 A1
(43) Pub. Date: Sep. 4, 2025

(54) ULTRASONICALLY BONDED COMPOSITE MATERIALS

(71) Applicant: DelStar Technologies, Inc., Alpharetta, GA (US)

(72) Inventors: Thomas Adjei, Slingerlands, NY (US); Rama Jude, Slingerlands, NY (US); John Cox, Middletown, DE (US); Andrew G. Platt, Reading, DE (US)

(21) Appl. No.: 19/068,492

(22) Filed: Mar. 3, 2025

Related U.S. Application Data
(60) Provisional application No. 63/560,830, filed on Mar. 4, 2024.

(51) Int. Cl. B01D 39/16; D04H 1/435; D04H 1/732

(52) U.S. Cl. CPC B01D 39/163; D04H 1/435; D04H 1/732; B01D 2239/0618; B01D 2239/0654; B01D 2239/0672; B01D 2239/1208; B01D 2239/1233; B01D 2239/1291; D10B 2505/04

(57) ABSTRACT

The present disclosure provides composite materials comprising reticular structures, such as nettings, mattings, grids, meshes or the like, ultrasonically bonded to outer layers of non-woven fibers. A composite material comprises a first layer of netting comprising strands and a second layer of nonwoven fibers in contact with the first layer. The nonwoven fibers are ultrasonically bonded to the strands of the netting at a plurality of attachment points. The basis weight of the netting and/or the fibers in the second layer are selected to optimize the bonding and increase the overall strength of the material. In embodiments wherein the composite material is used as a filter media, the filter has a longer lifespan, without compromising other performance factors, such as efficiency and capacity.

### CROSS-REFERENCE TO RELATED APPLICATIONS

This application claims the benefit of U.S. Provisional Application Ser. No. 63/560,830, filed Mar. 4, 2024, the complete disclosure of which is incorporated herein by reference for all purposes.

### TECHNICAL FIELD

This description generally relates to composite materials, and more particularly to composite materials configured for use as filter media.

### BACKGROUND

Polymeric netting materials are used for a wide variety of applications, such as drainage, insulation, ground vibration damping, noise control and ventilation in buildings, resin infusion media, foam flow media and resin transfer media for vacuum infusion and structural injection molding, erosion control, soil consolidation, landfill stabilization, reinforcement, separation, containment, protection, filtration media, separation membranes, membrane adsorbers, membrane catalysts or membrane bioreactors.

Polymeric nettings typically comprise flexible mattings, meshes or grids produced from polymer monofilaments, such as polyamide, nylon, polyester, polypropylene and the like. These monofilaments or strands are thermally bonded together where they cross to form a flexible, compression resistant matrix with a substantial amount of void space. Typically, the netting is formed by extruding a polymeric blend composition through dies with reciprocating or rotating parts to form the netting configuration. This creates cross machine direction strands that cross the machine direction strands, which flow continuously. After the extrusion, the netting is then typically stretched in the machine direction using a differential between two sets of nip rollers.

In some applications, one or more outer layer(s) of nonwoven fibers are bonded to the polymeric netting to form a filter media for use in, for example, a liquid filter. The fibers are typically either thermally bonded to the strands of the netting with heat and pressure, or they are directly adhered to the netting with a suitable adhesive or glue. The overall tensile strength of the filter media is at least partially reliant on the strength of the bond between the fibers and the netting. Increasing the tensile strength of the filter media increases the lifespan of the filter.

### SUMMARY

Composite materials and methods for manufacturing the composite materials are provided herein. The composite materials include reticular support structures, such as nettings, mattings, grid, meshes or the like, ultrasonically bonded to one or more outer layer(s) of nonwoven fibers and may be configured for use in a variety of applications, including but not limited to, liquid filters.

In one aspect, a composite material comprises a first layer comprising a support structure and a second layer in contact with the support structure. The second layer comprises non-woven fibers. The non-woven fibers are ultrasonically bonded to the support structure at a plurality of attachment points.

Suitable nonwoven materials include, but are not limited to, fibers, layers or webs that are melt blown, spun bond or spun lace, heat-bonded, bonded carded, air-laid, wet-laid, co-formed, needle punched, stitched, hydraulically entangled or the like. In certain embodiments, the fibers are wet-laid and/or melt blown fibers. In an exemplary embodiment, the fibers are wet-laid fibers.

In various embodiments, the support structure is a reticular support structure, such as a netting, matting, grid, mesh, or the like. The second layer comprises nonwoven fibers ultrasonically bonded to the strands of the reticular support structure (e.g., a netting) at a plurality of attachment points. Ultrasonically bonding the fibers to the netting is more convenient and cost effective than adhesives or other methods of laminating the fibers to the netting.

The basis weight of the netting and/or the fibers in the second layer are selected to optimize the bonding and increase the overall strength of the material. In embodiments wherein the composite material is used as a filter media, the filter has a longer lifespan, without compromising other performance factors, such as efficiency and capacity.

In various embodiments, the strands of the netting have a basis weight of at least about 80 gsm, or at least about 100 gsm, or at least about 110 gsm. In some embodiments, the stands of the netting have an average thickness of at least about 0.20 inches or at least about 0.025 inches. This configuration increases the surface area of the strands, thereby providing a stronger ultrasonic bond between the netting and the fibers in the second layer.

Suitable materials for the netting include, but are not limited to, high density polyethylene (HDPE), polyethylene, polypropylene (PP), metallocene PP, polylactic acid (PLA). thermoplastic polymers, Nylon, polybutylene terephthalate (PBT), thermoplastic elastomer (TBE), polyphenylene sulfide (PPS), polyvinylidene fluoride (PVDF) and combinations thereof. In an exemplary embodiment, the netting comprises HDPE, PP or combinations thereof.

The netting may be formed from any suitable method such as extrusion, co-extrusion, bi-component, and elastomeric nettings. In an exemplary embodiment, the netting is formed from a mono-extrusion process. The netting may comprise a plurality of apertures or holes having any suitable shape, such as diamond, circular, hexagonal, square, rectangular or combinations thereof. In an exemplary embodiment, the apertures have a substantially diamond shape. The apertures may have a size of at least about 50 microns, or at least about 150 microns, preferably at least about 250 microns. The strands may be formed at an angle of about 10 to about 90 degrees, or about 50 to about 80 degrees, or about 60 degrees.

In various embodiments, the nonwoven fibers include wet-laid fibers produced from a process in which the fibers are dispersed in a liquid, such as water or foam, and deposited onto a wire, drying matt, or filter on which the liquid is drained or removed to form a wet-laid media or web that is either dried or thermally bonded. In various embodiments, the wet-laid fibers comprise foam-laid fibers formed from a dispersion of such fibers in a foamed liquid.

In other embodiments, the nonwoven fibers may include melt blown fibers produced by melting a polymer, extruding the polymer through orifices or nozzles, and then blowing them into ultrafine fibers with hot, high-velocity air. The ultrafine fibers are collected on a rotary drum or a forming belt with a vacuum underneath the surface to form a nonwoven web. Suitable melt blown fibers include any polymer with thermoplastic behavior, such as polypropylene, polystyrene, polyesters, polyurethane, polyamides (nylons), polyethylene, polycarbonate, and combinations thereof.

In other embodiments, the second layer may comprise both wet-laid and melt blown fibers.

The fibers in the second layer may have a basis weight of about 20 gsm to about 300 gsm, or about 50 gsm to about 200 gsm. In an exemplary embodiment, the fibers have a basis weight of about at least about 150 gsm or at least about 200 gsm. Increasing the basis weight of the fibers may also provide a stronger ultrasonic bond between the netting and the fibers in the second layer.

The fibers may have thicknesses that are suitable for the application. In some embodiments, the fibers have at least one dimension in the range of about 1 to about 10,000 micrometers or about 1 to about 1,000 micrometers or about 10 to 100 micrometers. The thickness of the fibers may also be measured in denier, which is a unit of measure in linear mass density of fibers. In some embodiments, the fibers may have a linear density of about 1 denier to about 15 deniers, or at least about 8 denier, or at least about 10 denier or at least about 13 denier.

Suitable materials for the fibers include, but are not limited to, polypropylene, polyesters (PET), PEN polyester, PCT polyester, polypropylene, PBT polyester, co-polyamides, polyethylene, high density polyethylene (“HDPE”), LLDPE, cross-linked polyethylene, polycarbonates, polyacrylates, polyacrylonitriles, polyfumaronitrile, polystyrenes, styrene maleic anhydride, polymethylpentene, cyclo-olefinic copolymer or fluorinated polymers, polytetrafluoroethylene, perfluorinated ethylene and hexfluoropropylene or a copolymer with PVDF like P(VDF-TrFE) or terpolymers like P(VDF-TrFE-CFE), propylene, polyimides, polyether ketones, cellulose ester, nylon and polyamides, polymethacrylic, poly(methyl methacrylate), polyoxymethylene, polysulfonates, acrylic, modacrylic, styrenated acrylics, pre-oxidized acrylic, fluorinated acrylic, vinyl acetate, vinyl acrylic, ethylene vinyl acetate, styrene-butadiene, ethylene/vinyl chloride, vinyl acetate copolymer, latex, polyester copolymer, carboxylated styrene acrylic or vinyl acetate, epoxy, acrylic multipolymer, phenolic, polyurethane, cellulose, styrene or any combination thereof.

In an exemplary embodiment, the fibers are synthetic fibers and at least some of the fibers in the second layer comprise polyester. In certain embodiments, the fibers are 100% polyester.

In various embodiments, the fiber layers may be disposed on one side, or both sides, of the netting.

In various embodiments, the composite material may include multiple layers of netting. The two layers of netting may be disposed on opposite sides of the fiber layers, or they may be disposed between the fiber layers.

In another aspect, a product is provided comprising the composite material(s) described above. The product may comprise, for example, a filter media for a liquid filter, or a liquid filter, such as an oil filter, a gas filter, a fuel filter, a hydraulic filter, a chemical filter or the like.

In another aspect, a filter media comprises a first layer of netting comprising strands and a second layer of nonwoven fibers in contact with the first layer. The filter media has an average tensile strength of at least about 0.70 lbf, or at least about 0.75 lbf, or at least about 0.95 lbf. Increasing the tensile strength of the filter media increases the lifespan of the filter without compromising other performance functions of the filter media, such as efficiency and capacity.

In various embodiments, the filter media has a mean pore size of about 55 microns or less. In one such embodiment, basis weight of the fibers in the second layer is about 200 gsm and the mean pore size is about 34 microns or less.

In various embodiments, the filter media has a maximum pore size of about 76 microns or less. In one such embodiment, the basis weight of the fibers in the second layer is about 200 gsm and the maximum pore size is about 52 microns or less.

In various embodiments, the strands of the netting have a basis weight of at least about 80 gsm, or at least about 100 gsm, or at least about 110 gsm. In some embodiments, the stands of the netting have an average thickness of at least about 0.20 inches or at least about 0.025 inches.

### BRIEF DESCRIPTION OF THE DRAWINGS

The accompanying drawings, which are incorporated in and constitute a part of this specification, illustrate several embodiments of the disclosure and together with the description, explain the principles of the disclosure.

FIG. 1 is a cross-sectional view of a composite material comprising a first layer of nonwoven fibers and a layer of netting;

FIG. 2 is an exploded view of the netting of FIG. 1;

FIG. 3 illustrates a liquid cartridge filter;

FIG. 4 illustrates a liquid bag filter;

FIG. 5 illustrates a pleated filter cartridge; and

FIG. 6 illustrates a membrane filter cartridge.

### DESCRIPTION OF THE EMBODIMENTS

This description and the accompanying drawings illustrate exemplary embodiments and should not be taken as limiting, with the claims defining the scope of the present disclosure, including equivalents. Various mechanical, compositional, structural, and operational changes may be made without departing from the scope of this description and the claims, including equivalents. In some instances, well-known structures and techniques have not been shown or described in detail so as not to obscure the disclosure. Like numbers in two or more figures represent the same or similar elements. Furthermore, elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment. Moreover, the depictions herein are for illustrative purposes only and do not necessarily reflect the actual shape, size, or dimensions of the system or illustrated components.

It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Composite materials are provided that are configured for use in a variety of applications, such filter media for liquid filters. The filter media may be used in a variety of industries, such as pulp and paper, food and beverage, steel production, industrial process fluids, municipal, automotive, power generation, semiconductor manufacturing, mining/construction, petroleum/chemical refining, medical/pharmaceutical and general manufacturing.

For example, various embodiments include fuel filters, such as diesel fuel filters, hydrocarbon fuels, gasoline fuel filters, canister fuel filters, inline fuel filters, in-tank fuel filters, cartridge fuel filters, carburetor inlet filters, pump-outlet fuel filters, spin-on fuel filters and the like.

For example, various embodiments include gas turbine and compressor air intake filters, panel filters, filter presses, rotary drum filters, water plant treatment filters, biological filters, membrane bioreactor membranes, hydrocarbon filters, diesel filters, fuel filters, hydraulic fluid filters, food and beverage filters, semiconductor filters, microfiltration membranes, downstream membrane filtration, pharmaceutical and medical filters, waste water filters, industrial process and/or municipal filters, pipelines gas turbine and compressor air intake filters, panel filters, cartridge filters, bag filters, clean-in-place (CIP) filters, battery separators and the like.

For example, various embodiments include semiconductor processing filters to filter nano-sized particles and harmful contaminants during logic and chip fabrication, including microfiltration filters with hydrophobic or hydrophilic membranes, chemical filters, CMP filters, lithography filters, process gas filters and purifiers, chemical mechanical polishing filters, electrolyte plating, wastewater filters, wet etch and clean filters, PFOA filters and the like.

For example, various embodiments include filters for the food and beverage industry for removing solid and/or liquid contaminants, such as filters for manufacturing fruit juices and soft drinks, water filters in sinks and pitchers, basket centrifuges for producing salt, disc centrifuges for separating cream from milk, water purification membranes, rotary vacuum drum filters for separating sugar juice from mud, hydro cyclones for purifying starch, disc or tubular centrifuges for refining vegetable seed oils, decanter centrifuges or filter presses for de-watering separated grains in, for example, a distillery or brewery.

For example, various embodiments include filters for use in the pharmaceutical manufacturing industry for plasma fractionation, specialty enzymes, vitamins, diagnostics, phytopharmaceuticals, red biotechnology, white biotechnology and may include filters, such as magnetic filters, bag filters, self-cleaning filters, reverse osmosis filter membranes, ultrafiltration filter membranes and nanofiltration filter membranes and the like.

For example, in various embodiments, industrial filters are provided for removing solid and/or liquid contaminants from liquid process streams in refining, petrochemical, chemical, oil and gas, manufacturing paints, organic solvents, ink, petroleum and kerosene industrial water treatment, cosmetics, wineries and pharmaceuticals, including pleated filter cartridges, melt-blown filter cartridges, string wound filter cartridges, membrane filter cartridges, carbon filter cartridges, wound fiber depth style liquid filter cartridges, stainless steel filter cartridges, pleated series liquid cartridges, and other specialty filter cartridges. These filters may be rated from less than about 1 micron to about 100 microns.

For example, hydraulic filters are provided for removing particulate matter from hydraulic fluids. The hydraulic filters may be full flow or partial flow and may include, but are not limited to, oil filters, spin-on filters, return line filters, duplex filters, off-line and in-line filters and tank filters.

For example, various embodiments include municipal filters, such as filters used in water treatment plants. These filters may include, but are not limited to, screen filters, slow sand filters, disc filters, rapid sand filters, membrane filters, bag filters, membrane filters, reverse osmosis filters and the like.

For example, various embodiments include gas pipeline filters, such as turbine air filters, particulate filters, clay treater filters, amine filters, two-stage coalescer-separators, strainers, natural gas pipeline filters, Y-type filters, T-type filters, basket filters, magnetic filters, backwash filters and the like.

For example, various embodiments include power generation filters, such as hydropower generation filters, solar power generation filters, nuclear power generation filters, water filter cartridges, sintered metal filters, wedge wire filters, demister pad filters and the like.

For example, various embodiments include battery separators that serve as a mechanical barrier between the electrodes to prevent shorting while allowing for ionic transport through the electrolyte in the pores. For example, various embodiments include an alkaline battery separator, including, but not limited to, zinc-manganese dioxide (Zn/MnO₂), nickel-cadmium (Ni—Cd,), and nickel-hydrogen (Ni—H₂) batteries. The battery separators may include a substrate comprising blends of polyvinyl alcohol (PVA) fibers and cellulose or cellulose derivatives such as rayon or lyocell.

While the following description is primarily presented with respect to filter media and liquid filters, the devices and methods disclosed herein may be readily adapted for use in a variety of other applications. For example, the filter media disclosed herein may be useful in household cleaning products, roofing and flooring products, automobile upholstery and headliners, reusable bags, wallcoverings, filtration devices, insulation and the like. In addition, the individual nanoparticles that are isolated and generated in the processes described herein may be utilized in various coatings, composites and/or additives in, for example, polymers, food packaging, flame retardants, fuel cells, batteries, capacitors, nanoceramics, lights, material fabrication, manufacturing methods, reinforcement for composites, cement and other materials, medical diagnostic applications, medical therapeutic devices or therapies, tissue engineering, such as scaffolds for bone or tissue repair, potable waters, industrial process fluids, food and beverage products, pharmaceutical and biological agents, tissue imaging, medical therapy delivery, environmental applications, such as biodegradable compounds and the like.

Referring now to FIG. 1, a composite material 100 comprises a first layer of a reticular structure, such as a netting 110, and a second layer 120 bonded or laminated to netting 110. Second layer 120 comprises at least one set of nonwoven fibers ultrasonically joined to the strands in the netting 110. For example, first and second layers 110, 120 may be fed into an ultrasonic bonding device that applies high frequency ultrasonic vibrations to melt and/or bond the strands of netting 110 to the fibers in second layer 120 at a plurality of attachment points on the netting. To affect this bonding, the fibers of second layer 120 and netting 110 are transported through a gap between an ultrasonic vibrating unit, such as a horn, and a mating tool of an ultrasonic device, such as an anvil or rotating drum. The ultrasonic device applies little to no pressure to the fibers or the netting. This allows the thickness or loft of the fibers to be substantially maintained as the fibers are bonded to the netting 110.

The basis weight of the fibers in second layer 120 and netting 110 are selected to optimize the bonding and increase the overall strength of the material 100. In embodiments wherein material 100 is used as a filter media, the filter has a longer lifespan, without compromising other performance factors, such as efficiency and capacity.

The fibers in the second layer 120 preferably comprise nonwoven fibers. Suitable nonwoven materials include, but are not limited to, fibers, layers or webs that are melt blown, spun bond or spun lace, heat-bonded, bonded carded, air-laid, wet-laid, co-formed, needle punched, stitched, hydraulically entangled or the like. In certain embodiments, the fibers are wet-laid and/or melt blown fibers. In an exemplary embodiment, the fibers are wet-laid fibers.

Wet-laid fibers as defined herein are fibers produced from a process in which the fibers are dispersed in a liquid, such as water or foam, and deposited onto a wire, drying matt, or filter on which the liquid is drained or removed to form a web that is either dried or thermally bonded. A wet-laid process can be distinguished from a dry laid process which employs air-laid, carding techniques, or needle punch techniques.

In an exemplary embodiment, the fibers in the second layer are foam-laid fibers. Foam-laid fibers as defined herein are fibers formed from a dispersion of fibers in a foamed liquid. A pulp or fiber furnish is first prepared in a pulper, followed by dewatering, mixing with a foam or foamable liquid containing a surfactant and water. The fibers are dispersed in the foam and the formed fiber-foam is deposited on a wire and the main portion of the liquid, which is essentially in the form of foam, is removed by a suction. Surfactants may be of any suitable type, such as anionic, cationic, non-ionic and amphoteric surfactants. Additionally, wet-strengtheners, binders, creping chemicals etc. may be used. Surfactants used in the foaming process are generally regarded as having a negative influence on both the dry and wet tensile strength of a paper web.

Foam forming keeps water as a gluing element but uses the bubble structure and rheological properties of wet foam to keep the fibers apart. Thus, the flow of foam during forming can be laminar providing control over the distribution and orientation of the fibers. Moreover, foam stability affects final material density, and the average pore size can be tailored by adjusting the bubble size.

In other embodiments, the nonwoven fibers may include melt blown fibers produced by melting a polymer, extruding the polymer through orifices or nozzles, and then blowing them into ultrafine fibers with hot, high-velocity air. The ultrafine fibers are collected on a rotary drum or a forming belt with a vacuum underneath the surface to form a nonwoven web. Suitable melt blown fibers include any polymer with thermoplastic behavior, such as polypropylene, polystyrene, polyesters, polyurethane, polyamides (nylons), polyethylene, polycarbonate, and combinations thereof.

In other embodiments, the second layer may comprise both wet-laid and melt blown fibers.

The fibers in second layer 120 may be artificial or natural. Suitable materials for the fibers include, but are not limited to, polypropylene, polyesters (PET), PEN polyester, PCT polyester, polypropylene, PBT polyester, co-polyamides, polyethylene, high density polyethylene (“HDPE”), LLDPE, cross-linked polyethylene, polycarbonates, polyacrylates, polyacrylonitriles, polyfumaronitrile, polystyrenes, styrene maleic anhydride, polymethylpentene, cyclo-olefinic copolymer or fluorinated polymers, polytetrafluoroethylene, perfluorinated ethylene and hexfluoropropylene or a copolymer with PVDF like P (VDF-TrFE) or terpolymers like P (VDF-TrFE-CFE), propylene, polyimides, polyether ketones, cellulose ester, nylon and polyamides, polymethacrylic, poly(methyl methacrylate), polyoxymethylene, polysulfonates, acrylic, modacrylic, styrenated acrylics, pre-oxidized acrylic, fluorinated acrylic, vinyl acetate, vinyl acrylic, ethylene vinyl acetate, styrene-butadiene, ethylene/vinyl chloride, vinyl acetate copolymer, latex, polyester copolymer, carboxylated styrene acrylic or vinyl acetate, epoxy, acrylic multipolymer, phenolic, polyurethane, cellulose, styrene or any combination thereof. Other conventional fiber materials are contemplated.

In an exemplary embodiment, at least some of the fibers in second layer 120 comprise polyester. In certain embodiments, the fibers are 100% polyester.

The fibers may have a basis weight of about 20 gsm to about 300 gsm, or about 50 gsm to about 200 gsm, or about 50 gsm, or about 100 gsm, or about 150 gsm or about 200 gsm. In an exemplary embodiment, the fibers have a basis weight of about 150 gsm to about 200 gsm.

The fibers may have thicknesses that are suitable for the application. In some embodiments, the fibers have at least one dimension in the range of about 1 to about 10,000 micrometers or about 1 to about 1,000 micrometers or about 10 to 100 micrometers. The thickness of the fibers may also be measured in denier, which is a unit of measure in linear mass density of fibers. In some embodiments, the fibers may have a linear density of about 1 denier to about 15 deniers, or at least about 8 denier, or at least about 10 denier or at least about 13 denier.

The fibers may have many shapes in cross-section, including without limitation, circular, kidney bean, dog bone, trilobal, barbell, bowtie, star, Y-shaped, and others. With different denier fiber ranges within each portion. The fibers may include biocomponent fibers that include two or more different fibers bonded to each other. The fibers may comprise the same material or different materials. The fibers may comprise biocomponent fibers having a core and a sheath. The core may be concentric or eccentric relative to the longitudinal axis of the sheath.

Suitable materials for netting 110 include, but are not limited to, high density polyethylene (HDPE), low density polyethylene, polyethylene, polypropylene (PP), metallocene PP, polylactic acid (PLA). thermoplastic polymers, nylon, polybutylene terephthalate (PBT), thermoplastic elastomers (TBE), polyphenylene sulfide (PPS), polyvinylidene fluoride (PVDF) and combinations thereof. In an exemplary embodiment, the netting comprises HDPE, PP and combinations thereof.

Netting 110 may be formed from any suitable method such as extrusion, co-extrusion, bi-component, and elastomeric nettings. In an exemplary embodiment, the netting is formed from a mono-extrusion process. Generally, suitable methods for making the extruded netting includes extruding a polymeric blend composition through dies with reciprocating or rotating parts to form the netting configuration. This creates cross machine direction strands that cross the machine direction strands, which flow continuously. After the extrusion, the netting is then typically stretched in the machine direction using a differential between two sets of nip rollers.

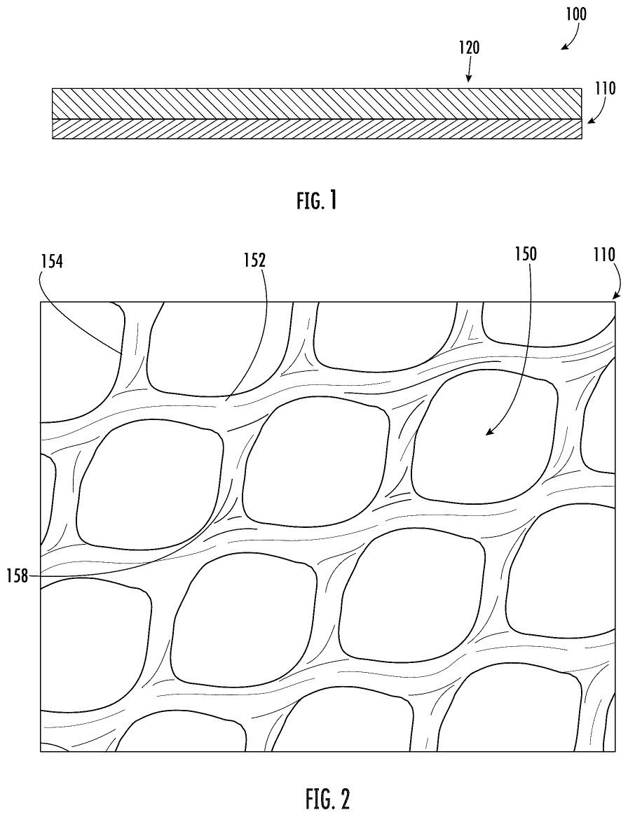

Netting 110 comprises a plurality of apertures or holes 150 (see FIG. 2). The apertures 150 may comprise pores or perforations. The apertures may have any suitable shape, such as diamond, circular, hexagonal, square, rectangular or combinations thereof. In an exemplary embodiment, the apertures 150 have a substantially diamond shape. The apertures 150 may have a size of at least about 50 microns, or at least about 150 microns, preferably at least about 250 microns.

Apertures 150 may be formed from a first series of strands 152 extending in one direction and a second series of strands 154 extending in a generally crosswise or transverse direction. The first and second sets of strands 152, 154 are extruded polymeric elongate members which cross and intersect during extrusion to form the net-like structure. The strands could also be formed of extruded strands that are knitted together rather than crossed during extrusion. In some embodiments, the strands are made of the same material. In other embodiments, the first set of strands 152 are made of a different material than the second set of strands 154.

The strands may be formed at an angle of about 10 to about 90 degrees, or about 50 to about 80 degrees, or about 60 degrees. In an exemplary embodiment, the apertures formed by the strands are symmetrical although it will be recognized that the apertures may be non-symmetrical in certain embodiments. The strand density is preferably less than about 100 strands per inch, or less than about 50 strands per inch, or less than about 44 strands per inch.

The strands 152, 154 preferably have a basis weight of at least about 80 gsm, or at least about 100 gsm, or at least about 110 gsm. The average thickness 158 of the strands 152, 154 is preferably about 0.006 inches to about 0.0400 inches, or about 0.02 inches to about 0.03 inches, or about 0.025 to about 0.026 inches. In an exemplary embodiment, the strands have an average thickness of about 0.0254 inches.

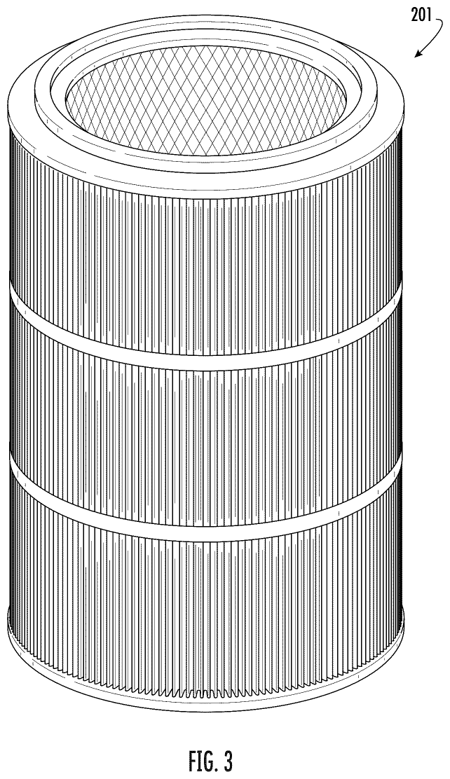

FIG. 3 illustrates a representative liquid filter 201 produced with various embodiments of the composite materials described herein. The composite material is rolled into a cylinder, cone, or other suitable shape and may be used in applications, such as gas turbine and compressor air intake filters, panel filters and the like. A cartridge is a tubular filter medium that is encased inside a housing. The direction of flow in a cartridge filter is typically from outside to the insides of the cartridge. Cartridges are usually made from synthetic or natural fibers and small metal wires. A core, made of stainless or tin-plated steel or polypropylene, is present on the axis of the tubular cartridge to support the media material. A purer filtrate is collected at its core.

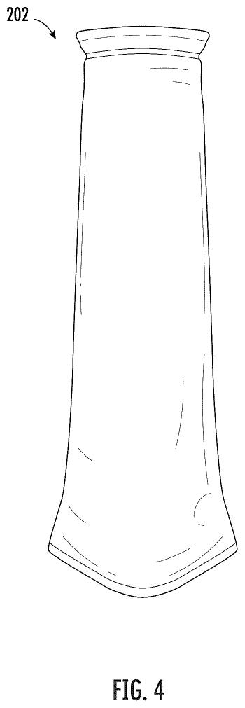

FIG. 4 illustrates a representative bag filter 202 produced with various embodiments of the composite materials described herein. Bag filters are one of the most popular filtration equipment. In this equipment, the process liquid passes through a permeable bag perforated with microscopic holes which act as the filter medium. The solid particles larger than the holes are entrapped and accumulated inside the bag. Its end has a sealing ring, usually made from stainless steel or plastic, to secure the bag inside the filtration vessel.

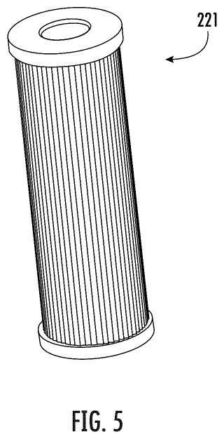

FIG. 5 illustrates a representative pleated filter cartridge 212 produced with various embodiments of the composite materials described herein. Filter cartridge 112 is particularly useful in surface filtration and may be constructed by pleating the media bonded at its ends to provide a larger filtration area for a minimal volume.

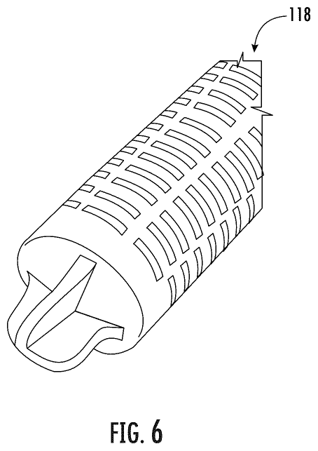

FIG. 6 illustrates a membrane filter cartridge 218 produced with various embodiments of the composite materials described herein. Filter cartridge 218 is particularly useful in the food and beverage, pharmaceutical, UPW, and semiconductor industries. Filter cartridge 218 may comprise PTFE, PES, PVDF and/or nylon and may have a pleated filter construction. The folded structure offers each pleated membrane filter cartridge a large filter area and high dirt holding capacity, hence efficiently increasing the service time.

Other types of liquid filters that may be developed with the materials disclosed herein include conical filter cartridges, spun-bonded cartridges, square-end cap filter cartridges, activated carbon filter cartridges, reverse osmosis membrane cartridges, alkaline filter cartridges, battery separators, ultraviolet filter cartridges, pocket filters, V-bank compact filters, panel filters, flat cell filters, pleated or unpleated bag cartridge filters, clean-in-place (CIP) filters and the like.

### EXAMPLES

The applicant manufactured and tested several different filter medias comprising a first layer of extruded polybutylene terephthalate (PBT) netting and a second layer of polyester wet-laid fibers ultrasonically bonded to the netting. The netting comprised two series of strands extending in a crosswise direction to form a net-like structure with diamond-shaped apertures. The strands had a relative angle with each other of about 60 degrees. The wet-laid fibers had a basis weight of about 150 gsm. Applicant tested the tensile strengths of two different sets of samples: (1) a control sample with wet-laid fibers and a netting having a basis weight of less than 100 gsm and an average thickness of about 0.02 inches (labeled “Control” in Table 1); and (2) a sample with wet-laid fibers and a thicker netting having a basis weight of about 110 gsm and an average thickness of about 0.0254 inches (labeled “Heavier Net” in Table 1). The tensile strengths were tested on the machine side, the opposite side of the machine and in the center of the composite material. Applicant then computed the average tensile strength of each material based on the individual tensile strengths in pound force (lbf) at these three points. The testing method was TAPPI/ANSI, T-1009 at 70 amps. TABLE 1 shows the results of this testing.

TABLE 1

| Sample | Average Tensile Strength (lbf) |
|---|---|
| Control 1 | 0.50 |
| Control 2 | 0.66 |
| Control 3 | 0.64 |
| Control 4 | 0.41 |
| Heavier Net 1 | 0.95 |
| Heavier Net 2 | 0.98 |
| Heavier Net 3 | 1.07 |

As shown in TABLE 1, the highest tensile strength of the control samples was 0.66 lbf, whereas all the heavier nets had tensile strengths significantly higher than 0.66 lbf, ranging from 0.95 to 1.07 lbf. Thus, the heavier net composite materials had a significantly higher tensile strength because the heavier nets had thicker strands with a larger surface area for ultrasonic bonding with the wet-laid fibers.

Applicant conducted a second series of tests of several different filter medias comprising a first layer of extruded polybutylene terephthalate (PBT) netting and a second layer of polyester wet-laid fibers ultrasonically bonded to the netting. The netting comprised two series of strands extending in a crosswise direction to form a net-like structure with diamond-shaped apertures and a basis weight of about 110 gsm. The strands had a relative angle with each other of about 60 degrees. The wet-laid fibers had varying basis weights ranging from about 50 gsm to about 200 gsm (labeled “50 gsm”, “150 gsm” and “200 gsm”). The tensile strengths were tested on the machine side, the opposite side of the machine and in the center of the composite material. Applicant then computed the average tensile strength of each material based on the individual tensile strengths in pound force (lbf) at these three points. The testing method was TAPPI/ANSI, T-1009 at 70 amps and 15 fpm with air. TABLE 2 shows the results of this testing.

TABLE 2

| Sample | Average Tensile Strength (lbf) | Average Thickness (mils) |
|---|---|---|
| 50 gsm | 0.5508 | 33.44 |
| 150 gsm | 0.9877 | 55.60 |
| 200 gsm | 1.6400 | 84.93 |

As shown in TABLE 2, as the basis weight and thickness of the wet-laid fibers increased, the average tensile strength increased because the thicker fibers had a larger surface area for ultrasonic bonding with the netting.

Applicant conducted a three series of tests of several different filter medias comprising a first layer of extruded polybutylene terephthalate (PBT) netting and a second layer of polyester wet-laid fibers ultrasonically bonded to the netting. The netting comprised two series of strands extending in a crosswise direction to form a net-like structure with diamond-shaped apertures and a basis weight of about 110 gsm. The strands had a relative angle with each other of about 60 degrees. The wet-laid fibers had varying basis weights ranging from about 50 gsm to about 200 gsm (labeled “50 gsm”, “100 gsm”, “150 gsm” and “200 gsm”). Applicant tested the above composite materials for dust holding capacity (in grams and mg/in²), efficiency at capturing contaminants (95% efficiency in microns and percentage efficiency at 25 microns), mean and maximum pore sizes (in microns), bubble point (in H²O) and air permeability (in cfm/ft²/min). The capacity was tested under J905 standard, and the efficiency was tested under J1985 standard. The results of this testing are shown below in TABLES 3 and 4.

TABLE 3

| | Capacity | Capacity | 95% Efficiency | % Efficiency |
|---|---|---|---|---|
| Sample | (g) | (mg/in²⁾ | (microns) | (@ 25 microns) |
| 100 gsm | 4.21 | 210.5 | 26-30 | 94.83 |
| 150 gsm | 3.6 | 180 | 30 | 90.3 |
| 200 gsm | 4.77 | 238.5 | 26-30 | 94.92 |

TABLE 4

| | Mean Flow Pore | Max Pore | Bubble | |
|---|---|---|---|---|
| | Diameter | Diameter | Point | Air Perm |
| Sample | (microns) | (microns) | (H²O) | (cfm/ft²/min) |
| 50 gsm | 55 | 76 | 3 | 312 |
| 100 gsm | 41 | 57 | 4 | 163 |
| 150 gsm | 41 | 56 | 4 | 115 |
| 200 gsm | 34 | 52 | 4.45 | 83 |

As shown, as the basis weight of the wet-laid fibers increased, the mean and max pore sizes of the composite material reduced, the bubble point increased, and the air permeability decreased. Thus, the thicker and heavier wet-laid fibers bonded more closely with the netting, thereby reducing pore sizes, increasing efficiency at capturing contaminants and decreasing air permeability.

Other embodiments will be apparent to those skilled in the art from consideration of the specification and practice of the embodiment disclosed herein. It is intended that the specification and examples be considered as exemplary only, with a true scope and spirit of the embodiment being indicated by the following claims.

For example, in a first aspect, a first embodiment is a composite material comprising a first layer including a support structure and a second layer in contact with the first layer and comprising nonwoven fibers. The nonwoven fibers are ultrasonically bonded to the support structure.

In another aspect, a first embodiment is a composite material comprising a first layer of netting comprising strands and a second layer in contact with the first layer, the second layer comprising nonwoven fibers. The nonwoven fibers are ultrasonically bonded to the strands of the netting at a plurality of attachment points.

A second embodiment is the first embodiment, wherein the fibers are at least partially fused to the strands at the plurality of attachment points.

A third embodiment is any combination of the first two embodiments, wherein the strands of the netting have a basis weight of at least about 100 gsm.

A 4^{th} embodiment is any combination of the first 3 embodiments, wherein the basis weight is at least about 110 gsm.

A 5^{th} embodiment is any combination of the first 4 embodiments, wherein the wet-laid fibers are foam-laid fibers.

A 6^{th} embodiment is any combination of the first 5 embodiments, wherein the nonwoven fibers comprise a material selected from the group consisting of polypropylene, polyester, polypropylene, co-polyamides, polyethylene, polycarbonate, polyacrylate, polyacrylonitrile, polystyrene, styrene maleic anhydride, propylene, polyimide, polyether ketone, cellulose ester, nylon and polyamide, acrylic, vinyl acetate, ethylene vinyl acetate, styrene-butadiene, ethylene/vinyl chloride, vinyl acetate copolymer, latex, epoxy, polyurethane, cellulose, styrene and combinations thereof.

A 7^{th} embodiment is any combination of the first 6 embodiments, wherein the nonwoven fibers are wet-laid fibers.

An 8^{th} embodiment is any combination of the first 7 embodiments, wherein the wet-laid fibers comprise polyester.

A 9^{th} embodiment is any combination of the first 8 embodiments, wherein the stands of the netting have a thickness of at least about 0.025 inches.

A 10^{th} embodiment is any combination of the first 9 embodiments, wherein the fibers of the second layer have a linear density of about 10 Denier or greater.

An 11^{th} embodiment is any combination of the first 10 embodiments, wherein the linear density of about 13 Denier or greater.

A 12^{th} embodiment is any combination of the first 11 embodiments, wherein the fibers of the second layer have a basis weight of at least about 50 gsm.

A 13^{th} embodiment is any combination of the first 12 embodiments, wherein the basis weight is at least about 100 gsm.

A 14^{th} embodiment is any combination of the first 13 embodiments, wherein the basis weight is at least about 150 gsm.

A 15^{th} embodiment is any combination of the first 14 embodiments, wherein the basis weight is about 200 gsm.

A 16^{th} embodiment is any combination of the first 15 embodiments, wherein the first layer of netting comprises a material selected from the group consisting of high-density polyethylene (HDPE), polyethylene, polypropylene (PP), metallocene PP, polylactic acid (PLA). thermoplastic polymers, Nylon, polybutylene terephthalate (PBT), thermoplastic elastomer (TBE), polyphenylene sulfide (PPS), polyvinylidene fluoride (PVDF) and combinations thereof.

A 17^{th} embodiment is any combination of the first 16 embodiments, wherein the first layer of netting comprises HDPE, PP or combinations thereof.

In another aspect, a filter media is provided comprising the composite material of any combination of the above 17 embodiments.

In another aspect, a liquid filter is provided comprising the composite material of any combination of the above 17 embodiments.

In another aspect, an oil filter is provided comprising the composite material of any combination of the above 17 embodiments.

In another aspect, a gas filter is provided comprising the composite material of any combination of the above 17 embodiments.

In another aspect, a fuel filter is provided comprising the composite material of any combination of the above 17 embodiments.

In another aspect, a hydraulic filter is provided comprising the composite material of any combination of the above 17 embodiments.

In another aspect, a chemical filter is provided comprising the composite material of any combination of the above 17 embodiments.

In another aspect, a first embodiment is a filter media comprising a first layer of netting comprising strands and a second layer in contact with the first layer, the second layer comprising nonwoven fibers. The filter media has an average tensile strength of at least about 0.70 lbf.

A second embodiment is the first embodiment, wherein the average tensile strength is at least about 0.75 lbf.

A third embodiment is any combination of the first 2 embodiments, wherein the average tensile strength is at least about 0.95 lbf.

A 4^{th} embodiment is any combination of the first 3 embodiments, wherein the filter media has a mean pore size of about 55 microns or less.

A 5^{th} embodiment is any combination of the first 4 embodiments, wherein a basis weight of the fibers in the second layer is about 200 gsm and the mean pore size is about 34 microns or less.

A 6^{th} embodiment is any combination of the first 5 embodiments, wherein the filter media has a maximum pore size of about 76 microns or less.

A 7^{th} embodiment is any combination of the first 6 embodiments, wherein a basis weight of the fibers in the second layer is about 200 gsm and the maximum pore size is about 52 microns or less.

An 8^{th} embodiment is any combination of the first 7 embodiments, wherein the fibers in the second layer are ultrasonically bonded to the strands of the netting at a plurality of attachment points.

A 9^{th} embodiment is any combination of the first 8 embodiments, wherein the nonwoven fibers are wet-laid fibers.

A 10^{th} embodiment is any combination of the first 9 embodiments, wherein the fibers in the second layer are foam-laid fibers.

An 11^{th} embodiment is any combination of the first 10 embodiments, wherein the fibers comprise polyester.

A 12^{th} embodiment is any combination of the first 11 embodiments, wherein the strands of the netting have a basis weight of at least about 100 gsm.

A 13^{th} embodiment is any combination of the first 12 embodiments, wherein the basis weight is at least about 110 gsm.

In another aspect, a liquid filter is providing comprising the filter media of any combination of the first 13 embodiments.

In another aspect, an oil filter is providing comprising the filter media of any combination of the first 13 embodiments.

In another aspect, a gas filter is providing comprising the filter media of any combination of the first 13 embodiments.

In another aspect, a fuel filter is providing comprising the filter media of any combination of the first 13 embodiments.

In another aspect, a hydraulic filter is providing comprising the filter media of any combination of the first 13 embodiments.

In another aspect, a chemical filter is providing comprising the filter media of any combination of the first 13 embodiments.

In another aspect, a first embodiment is a method of manufacturing a filter media. The method comprises providing a netting comprising strands, providing a second layer of nonwoven fibers, and ultrasonically bonding the nonwoven fibers to the strands of the netting.

A second embodiment is the first embodiment, wherein the nonwoven fibers are wet-laid fibers.

A third embodiment is any combination of the first 2 embodiments, further comprising foam laying the fibers in the second layer.

A 4^{th} embodiment is any combination of the first 3 embodiments, wherein the wet-laid fibers are ultrasonically bonded to the strands in the netting at a plurality of attachment points.

A 5^{th} embodiment is any combination of the first 4 embodiments, wherein the strands of the netting have a basis weight of at least about 100 gsm.

A 6^{th} embodiment is any combination of the first 5 embodiments, wherein the basis weight is at least about 110 gsm.

A 7^{th} embodiment is any combination of the first 6 embodiments, wherein the stands of the netting have a thickness of at least about 0.025 inches.

In another aspect, a liquid filter is provided manufactured from the method of any combination of the above 7 embodiments.

1. A composite material comprising:
a first layer comprising a support structure; and
a second layer in contact with the support structure, the second layer comprising nonwoven fibers; and
wherein the nonwoven fibers are ultrasonically bonded to the support structure at a plurality of attachment points.

2. The composite material of claim 1, wherein the support structure is a reticular support structure and the fibers are at least partially fused to the support structure at the plurality of attachment points.

3. The composite material of claim 2, wherein the reticular support structure comprises a netting comprising strands.

4. The composite material of claim 3, wherein the strands of the netting have a basis weight of at least about 100 gsm.

5. The composite material of claim 1, wherein the nonwoven fibers are wet-laid fibers.

6. The composite material of claim 5, wherein the wet-laid fibers are foam-laid fibers.

7. The composite material of claim 5, wherein the wet-laid fibers comprise polyester.

8. The composite material of claim 3, wherein the stands of the netting have a thickness of at least about 0.025 inches.

9. The composite material of claim 1, wherein the fibers of the second layer have a linear density of about 10 Denier or greater.

10. The composite material of claim 9, wherein the linear density is about 13 Denier or greater.

11. The composite material of claim 1, wherein the fibers of the second layer have a basis weight of at least about 50 gsm.

12. The composite material of claim 3, wherein the netting comprises HDPE, PP, or combinations thereof.

13. A liquid filter media comprising the composite material of claim 1.

14. A filter media comprising:
a first layer comprising a support structure;
a second layer in contact with the support structure, the second layer comprising nonwoven fibers; and
wherein the filter media has an average tensile strength of at least about 0.70 lbf.

15. The filter media of claim 14, wherein the average tensile strength is at least about 0.75 lbf.

16. The filter media of claim 14, wherein the average tensile strength is at least about 0.95 lbf.

17. The filter media of claim 14, wherein the filter media has a mean pore size of about 55 microns or less.

18. The filter media of claim 17, wherein a basis weight of the fibers in the second layer is about 200 gsm and the mean pore size is about 34 microns or less.

19. The filter media of claim 17, wherein the filter media has a maximum pore size of about 76 microns or less.

20. The filter media of claim 19, wherein a basis weight of the fibers in the second layer is about 200 gsm and the maximum pore size is about 52 microns or less.

21. The filter media of claim 14, wherein the support structure comprises a netting comprising strands and the fibers in the second layer are ultrasonically bonded to the strands of the netting at a plurality of attachment points.
